(19) United States
(12) Patent Application Publication
(10) Pub. No.: US 2007/0057849 A1
(43) Pub. Date: Mar. 15, 2007

(54) Antenna for dual band operation

(75) Inventors: Young-min Moon, Seoul (KR); Young-eil Kim, Suwon-si (KR); Gyoo-soo Chae, Cheonan-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/387,924

(22) Filed: Mar. 24, 2006

(30) Foreign Application Priority Data
Sep. 13, 2005 (KR) 2005-85120

(51) Int. Cl. H01Q 1/38

(52) U.S. Cl. 343/700 MS

(57) ABSTRACT

Provided is a dual band antenna including: a ground surface; a feeder feeding a predetermined current; an induction radiator including one end connected to the ground surface and the other end connected to the feeder; and a parasitic radiator including an end connected to the ground surface and the other end opened. An antenna having a smaller size than an existing IFA mainly used as an internal antenna in a portable terminal can be provided through the dual band antenna including the induction radiator and the parasitic radiator.

### CROSS-REFERENCE TO RELATED APPLICATIONS

This application claims the priority from Korean Patent Application No. 2005-85120, filed Sep. 13, 2005, in the Korean Intellectual Property Office, the disclosure of which is incorporated herein by reference.

### BACKGROUND OF THE INVENTION

1. Field of the Invention

The present invention relates to an antenna for a dual band operation, and more particularly, to a planar dual band antenna capable of efficiently using an internal space of a portable terminal and improving a radiation pattern and efficiency thereof.

2. Description of the Related Art

Portable terminals refer to cellular phones or personal digital assistants (PDAs) with which users can transmit and/or receive data during their movements.

Examples of antennas used in conventional portable terminals include external antennas. The external antennas are positioned in external spaces of the portable terminals and classified into monopole antennas and helical antennas.

The monopole antennas are formed of conductive bars and have lengths determined by frequency domains. Thus, although the portable terminals are made compact, the lengths of the monopole antennas are longer than the portable terminals. Also, the monopole antennas may be damaged by external impacts.

The helical antennas are formed of conductive coils wound on a conductive plate. The helical antennas are shorter than the monopole antennas and may be damaged by external impacts. Also, the external antennas are positioned above heads of users during the use of the portable terminal, and thus electric waves may adversely affect the users. Inverted F Antennas (IFAs) have been suggested to solve the problems of the external antennas.

FIG. 1 is a cross-sectional view of a conventional IFA, and FIG. 2 is a perspective view of the conventional IFA shown in FIG. 1. Referring to FIGS. 1 and 2, the conventional IFA includes a ground unit 10, a radiator 12, a connector 14, and a feeder 16 to form a 3-dimensional structure. The IFA will now be described in detail.

The radiator 12 is disposed above the ground unit 10, and the connector 14 connects the radiator 12 to the ground unit 10 and is positioned at an end of the radiator 12. The feeder 16 feeds a current to the radiator 12. In general, impedance matching is determined by a position of the feeder 16 and a length of the connector 14. A size of the conventional IFA is about 15 mm×15 mm×6 mm based on 2.4 GHz.

As described above, the IFA is an internal antenna installed inside a portable terminal and thus solves the problems of an external antenna. Also, the IFA is more easily produced than the external antenna.

However, as portable terminals are made compact and light, efforts to realize antennas having sizes smaller than 15 mm×15 mm×6 mm have been made. There is a limit to how compact and light a conventional IFA can be in terms of a gap between a radiator and a ground unit, sizes of the radiator and the ground unit, and the like. Also, a process of producing the conventional IFA is complicated due to structures of the ground unit and a feeder.

Efforts to make compact dual band antennas operable in portable terminal providing multiple-band wireless communication services have been made. For example, efforts to make compact and light dual band antenna operating in standard operation frequencies of 2.4 GHz and 5 Hz of IEEE 802.11a/b/g have been made. However, the conventional IFA still has problems to be overcome.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An aspect of the present general inventive concept is to provide a compact dual band antenna that can be installed inside a portable terminal and have an improved radiation pattern and improved efficiency.

According to an aspect of the present invention, there is provided a dual band antenna including: a ground surface; a feeder feeding a predetermined current; an induction radiator comprising one end connected to the ground surface and the other end connected to the feeder; and a parasitic radiator comprising one end connected to the ground surface and the other end opened.

The induction radiator and the parasitic radiator may form resonances in two frequency bands.

The induction radiator may form the resonance in a high frequency band of the two frequency bands, and the parasitic radiator may be connected to the induction radiator to form the resonance in a low frequency band of the two frequency bands.

The high frequency band may be within and without 5 GHz, and the low frequency band may be within and without 2.4 GHz.

The inductor radiator may be a strip folded at least one time. The parasitic radiator may be a strip folded at least one time. The induction radiator and the parasitic radiator may be formed on an identical plane of the ground surface.

The induction radiator may include: a first induction radiator strip including an end vertically connected to a side of the ground surface; a second induction radiator strip including one end connected to the other end of the first induction radiator strip and disposed horizontally to the side of the ground surface; a third induction radiator strip including one end connected to the other end of the second induction radiator strip and disposed vertically to the side of the ground surface; and a fourth induction radiator strip including one end connected to the other end of the third induction radiator strip and the other end connected to the feeder and disposed horizontally to the side of the ground surface.

The first through fourth induction radiator strips may be formed of a single body.

The parasitic radiator may include: a first parasitic radiator strip including an end vertically connected to the side of the ground surface; a second parasitic radiator strip including one end connected to the other end of the first parasitic radiator strip and disposed horizontally to the side of the ground surface; a third parasitic radiator strip including one end connected to the other end of the second parasitic radiator strip and disposed vertically to the side of the ground surface; and a fourth parasitic radiator strip including one end connected to the other end of the third parasitic radiator strip and the other end opened and disposed horizontally to the side of the ground surface.

The first through fourth parasitic radiator strips may be formed of a single body.

The parasitic radiator may include: a first parasitic radiator strip including an end vertically connected to the side of the ground surface; and a second parasitic radiator strip including one end connected to the other end of the first parasitic radiator strip and the other end opened and disposed horizontally to the side of the ground surface.

The first and second parasitic radiator strips may be formed of a single body. The second parasitic radiator strip may keep a longer predetermined distance from the side of the ground surface than the third induction radiator strip.

The feeder may be realized so that a signal input node PCB (printed circuit board) on which the dual band antenna is formed directly supplies a current to the induction radiator.

### BRIEF DESCRIPTION OF THE DRAWINGS

The above aspects and features of the present invention will be more apparent by describing certain exemplary embodiments of the present invention with reference to the accompanying drawings, in which:

FIG. 1 is a cross-sectional view of a conventional 3-dimensional IFA;

FIG. 2 is a perspective view of the conventional 3-dimensional IFA shown in FIG. 1;

FIG. 3 is a cross-sectional view of a dual band antenna according to an exemplary embodiment of the present invention;

FIG. 4 is a cross-sectional view illustrating examples of lengths of respective portions of an induction radiator and a parasitic radiator realized to resonate the dual band antenna of FIG. 3 in a dual band of frequencies of 5.3 GHz and 2.4 GHz;

FIGS. 5A and 5B are cross-sectional views illustrating a distribution of a surface current during high and low frequency resonances of the dual band antenna shown in FIG. 4;

FIG. 6 is a cross-sectional view of a dual band antenna according to another exemplary embodiment of the present invention;

FIG. 7 is a cross-sectional view illustrating examples of lengths of respective portions of an induction radiator and a parasitic radiator realized to resonate the dual band antenna of FIG. 6 in a dual band of frequencies of 5.3 GHz and 2.4 GHz;

FIGS. 8A and 8B are cross-sectional views illustrating a distribution of a surface current during high and low frequency resonances of the dual band antenna shown in FIG. 7;

FIGS. 9A and 9B are graphs illustrating results of return losses measured with respect to operation frequencies of the dual band antennas shown in FIGS. 3 and 6; and

FIGS. 10A and 10B are graphs illustrating measured results of radiation patterns of the dual band antennas shown in FIGS. 3 and 6.

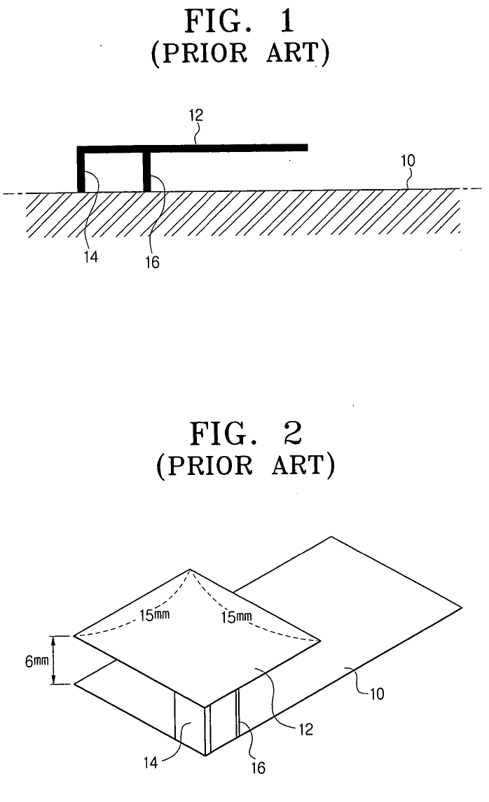

### DETAILED DESCRIPTION OF THE EXEMPLARY EMBODIMENTS

Certain exemplary embodiments of the present invention will be described in greater detail with reference to the accompanying drawings.

In the following description, same drawing reference numerals are used for the same elements even in different drawings. The matters defined herein are described at a high-level of abstraction to provide a comprehensive yet clear understanding of the invention. It is also to be noted that it will be apparent to those ordinarily skilled in the art that the present invention is not limited to the description of the exemplary embodiments provided herein.

Hereinafter, a planar dual band antenna according to the present invention will be described with reference to the attached drawings. In other words, the present invention suggests a 2-dimensional dual band antenna instead of a conventional 3-dimensional IFA.

FIG. 3 is a cross-sectional view of a dual band antenna according to an exemplary embodiment of the present invention. Referring to FIG. 3, the dual band antenna includes an induction radiator 110, a parasitic radiator 120, a feeder 130, and a ground surface 140. In the dual band antenna, the induction radiator 110 is used to resonate a frequency in a high frequency band, and the parasitic radiator 120 is combined with the induction radiator 110 to be used to increase a bandwidth and resonate a frequency in a low frequency band.

One end of the induction radiator 110 is connected to the ground surface 140, and the other end of the induction radiator 110 is connected to the feeder 130 to have a loop type monopole antenna structure and operate in a high frequency band to form a high frequency resonance. In the present embodiment, the induction radiator 110 may form the high frequency resonance roughly around a frequency of 50 GHz. For this purpose, a total length of the induction radiator 110 may correspond to a ½ wavelength of an operation frequency in the high frequency band to be resonated by the induction radiator 110.

The induction radiator 110 may be a plane strip folded at least one or more times. Therefore, the height and the width of the induction radiator 110 are reduced, which in turn results in the overall reduction of area of the ground surface 140 upon which the induction radiator 110 is formed.

In more detail, the induction radiator 110 may include first through fourth induction radiator strips 110a through 1110d. For convenience, the induction radiator 110 is divided into the first through fourth induction radiator strips 110a through 110d that may be formed of one strip, based on folded portions of the induction radiator 110.

The first induction radiator strip 110a has one end vertically connected tot the side A-A′ of the ground surface 140 and the other end connected to an end of the second induction radiator strip 1110b.

The second induction radiator strip 110b has one end connected to the other end of the first induction radiator strip 110a and the other end connected to an end of the third induction radiator strip 110c to be disposed horizontally to the side A-A′ of the ground surface 140.

The third induction radiator strip 1110c has one end connected to the other end of the second induction radiator strip 110b and the other end connected to an end of the fourth induction radiator strip 110d to be disposed vertically to the side AA′ of the ground surface 140.

The fourth induction radiator strip 110d has one end connected to the other end of the third induction radiator strip 110c and the other end connected to the feeder 130 to be disposed horizontally to the side A-A′ of the ground surface 140. Also, the first through fourth induction radiator strips 110a through 110d may be disposed on the same plane as the ground surface 140.

The parasitic radiator 120, which has one end connected to the ground surface 140 and the other end opened, is electromagnetically connected to the induction radiator 110 to increase bandwidth, and forms a low frequency resonance in a low frequency band (roughly around 2.4 GHz). In the dual band antenna according to the present invention, the low frequency resonance is generated by an expansion of length of the dual band antenna resulting from connecting the parasitic radiator 120 with the induction radiator 110. The low frequency resonance frequency is determined by the length of the parasitic radiator 120. In the present invention, the parasitic radiator 120 may form the low frequency resonance roughly around 2.4 GHz. The entire length and shape of the parasitic radiator 120 which forms the low frequency resonance will be described below in detail.

The parasitic radiator 120 may also be formed of a plane strip folded at least one or more times. Therefore, the height and the width of the parasitic radiator 120 formed along the side A-A′ of the ground surface 140 are reduced. As a result, the area of the ground surface 140 upon which the parasitic radiator 120 is formed can be reduced.

In more detail, the parasitic radiator 120 may include first through fourth parasitic radiators 120a through 120d. For convenience, the parasitic radiator 120 is divided into the first through fourth parasitic radiators 120a through 120d that may be formed of one strip, based on folded portions.

The first parasitic radiator strip 120a has one end vertically connected to the side A-A′ of the ground surface 140 and the other end connected to an end of the second parasitic radiator strip 120b.

The second parasitic radiator strip 120b has one end connected to the other end of the first parasitic radiator strip 120a and the other end connected to an end of the third parasitic strip 120c and is disposed horizontally to the side A-A′ of the ground surface 140.

The third parasitic radiator strip 120c has one end connected to the other end of the second parasitic radiator strip 120b and the other end connected to an end of the fourth parasitic radiator strip 120d and is disposed vertically to the side A-A′ of the ground surface 140.

The fourth parasitic radiator strip 120d has one end connected to the other end of the third parasitic radiator strip 120c and the other end opened and is disposed horizontally to the side A-A′ of the ground surface 140. The first through fourth parasitic radiator strips 120a through 120d may be disposed on the same plane.

According to the above-described structure, the induction radiator 110, the parasitic radiator 120, and the ground surface 140 can be realized in plane shapes which results in further reduction of volume of the dual band antenna compared to that of the conventional IFA.

The feeder 130 is not connected to the ground surface 140 but may be realized so that a signal input node (not shown) of a printed circuit board (PCB) upon which the dual band antenna is realized supplies a current to the induction radiator 110. Thus, the feeder 130 may have a simpler structure than a feeder of the conventional IFA.

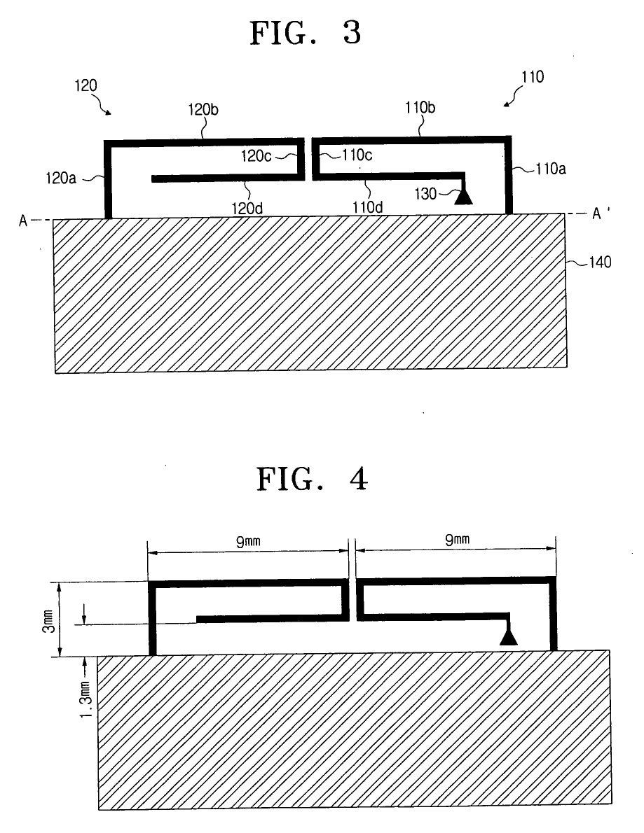

FIG. 4 is a cross-sectional view illustrating examples of lengths of respective portions of an induction radiator and a parasitic radiator realized to resonate the dual band antenna of FIG. 3 in a dual band of frequencies of 5.3 GHz and 2.4 GHz. Although not shown, the radiator 110 and the parasitic radiator 120 are realized as the plane strips and thus can each have a thickness of about 0.8 mm.

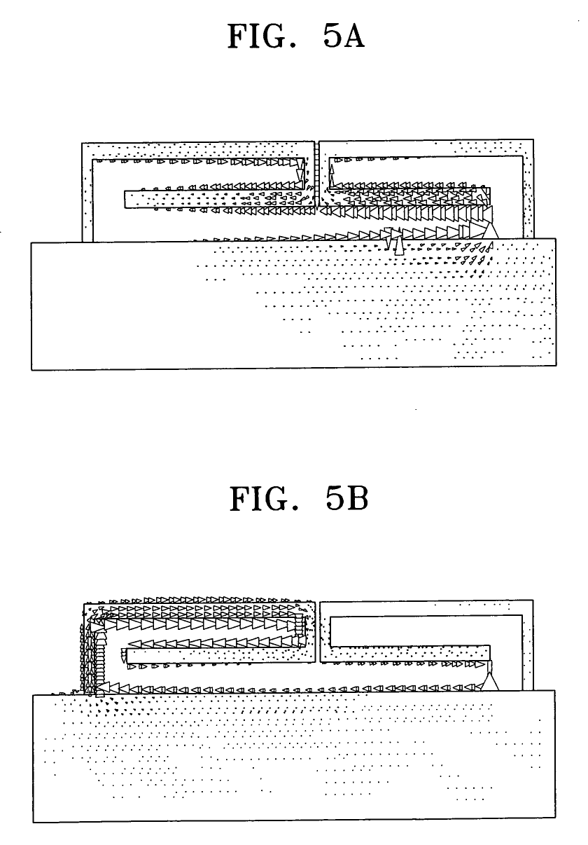

FIG. 5A is a cross-sectional view illustrating a distribution of a surface current during a high frequency resonance of the dual band antenna shown in FIG. 4. FIG. 5B is a cross-sectional view illustrating a distribution of a surface current during a low frequency resonance of the dual band antenna shown in FIG. 4.

As shown in FIG. 5A, the induction radiator 110 connected to the feeder 130 forms a high frequency (roughly around 5 GHz) resonance as shown in FIG. 5A, and the parasitic radiator 110 is combined with the induction radiator 110 to form a low frequency (roughly around 2 GHz) resonance as shown in FIG. 5B.

The size of the conventional IFA shown in FIG. 2 is 15 mm×15 mm×6 mm at the operation frequency of 2.4 GHz as described above, while a size of the dual band antenna shown in FIG. 3 is greatly reduced, i.e., 18 mm×3 mm×0.8 mm at the operation frequency roughly around 2 GHz (2.4 GHz) or 5 GHz (5.4 GHz).

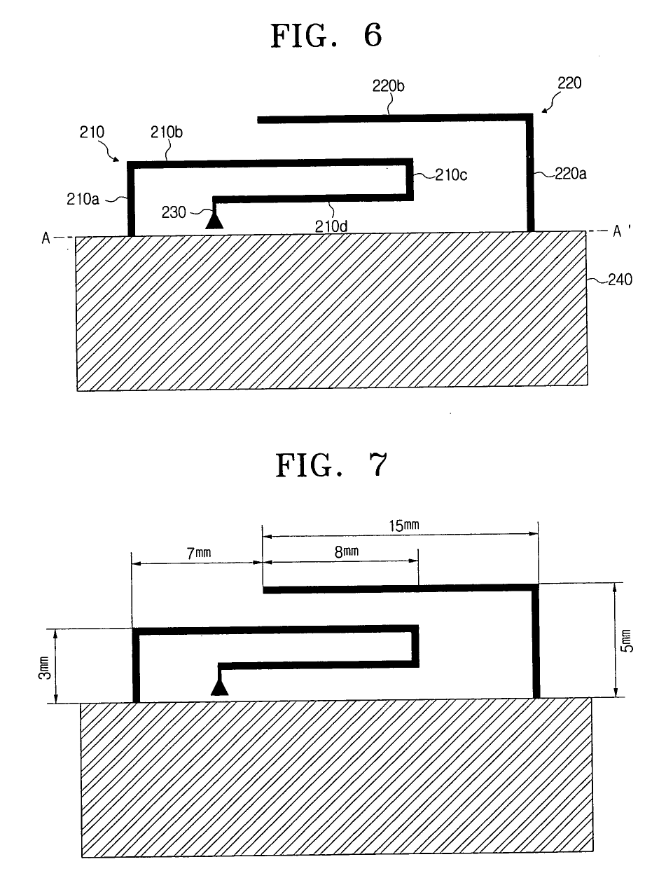

FIG. 6 is a cross-sectional view of a dual band antenna according to another exemplary embodiment of the present invention

Referring to FIG. 6, the dual band antenna includes an induction radiator 210, a parasitic radiator 220, a feeder 230, and a ground surface 240. In the present exemplary embodiment, the induction radiator 210 is used to resonate a frequency in a high frequency band, and the parasitic radiator 220 is used to increase bandwidth and realize a dual band (low and high frequency bands).

The induction radiator 210 has one end connected to the ground surface 240 and the other end connected to the feeder 230 to have a loop type monopole antenna and forms a high frequency resonance in the high frequency band. In the present exemplary embodiment, the induction radiator 210 may form the high frequency resonance roughly around 5 GHz. For this purpose, the total length of the induction radiator 210 may correspond to a ½ wavelength of an operation frequency in the high frequency band to be resonated by the induction radiator 210.

The induction radiator 210 may be formed of a plane strip folded at least one or more times. Therefore, the height and the width of the induction radiator 210 formed along the side A-A′ of the ground surface 240 are reduced.

In more detail, the induction radiator 210 may include first through fourth induction radiator strips 210a through 210d. For convenience, the induction radiator 210 is divided into the first through fourth induction radiator strips 210a through 210d that may be formed of one strip, based on folded portions.

The first induction radiator strip 210a has one end vertically connected to the side A-A′ of the ground surface 240 and the other end connected to an end of the second induction radiator strip 210b.

The second induction radiator strip 210 has one end connected to the other end of the first induction radiator strip 210a and the other end connected to an end of the third induction radiator strip 210c and is disposed horizontally to the side A-A′ of the ground surface 240.

The third induction radiator strip 210c has one end connected to the other end of the second induction radiator strip 210b and the other end connected to an end of the fourth induction radiator strip 210d and is disposed vertically to the side A-A′ of the ground surface 240.

The fourth induction radiator strip 210d has one end connected to the other end of the third induction radiator strip 210c and the other end connected to the feeder 230 and is disposed horizontally to the side A-A′ of the ground surface 240. Also, the first through fourth induction radiator strips 210a through 210d may be disposed on the same plane as the ground surface 240.

The parasitic radiator 220, which has one end connected to the ground surface 240 and the other end opened, is electrically connected to the induction radiator 210 to increase bandwidth, and forms a low frequency resonance in a low frequency band (roughly around 2.4 GHz). In the dual band antenna shown in FIG. 6, the low frequency resonance is generated by an expansion of length of the dual band antenna resulting from connecting the parasitic radiator 220 with the induction radiator 210. The low frequency resonance depends on a total length of the parasitic radiator 220 and a crossing length between the parasitic radiator 220 and the induction radiator 210. In the present exemplary embodiment, the parasitic radiator 220 may form the low frequency resonance roughly around 2.4 GHz. The total length and shape of the parasitic radiator 220 which forms the low frequency resonance will be described below.

The parasitic radiator 220 may be formed of a plane strip folded at least one or more times. Therefore, the height and the width of the parasitic radiator 220 formed along the side A-A′ of the ground surface 240 are reduced. The parasitic radiator 220 may keep a longer predetermined distance from the ground surface 210 than the induction radiator 210 and overlap with the induction radiator 210.

In more detail, the parasitic radiator 220 may include first and second parasitic radiator strips 220a and 220b.

The first parasitic radiator strip 220a has one end vertically connected to the side A-A′ of the ground surface 240 and the other end connected to an end of the second parasitic radiator strip 220b.

The second parasitic radiator strip 220b has one end connected to the other end of the first parasitic radiator strip 220a and the other end opened and is disposed horizontally to the side A-A′ of the ground surface 240. Here, the second parasitic radiator strip 220b keeps a longer predetermined distance from the side A-A′ of the ground surface 240 than the third induction radiator strip 210c.

Also, the first and second parasitic radiator strips 220a and 220b may be disposed on the same plane as the ground surface 240.

According to the above-described structure, the induction radiator 210, the parasitic radiator 220, and the ground surface 240 are realized in plane shapes which results in further reduction of volume of the dual band antenna compared to that of the conventional IFA. Also, a length of the dual band antenna of the present exemplary embodiment horizontal to the side A-A′ of the ground surface 240 can be further reduced compared to the dual band antenna shown in FIG. 3.

As in the previous exemplary embodiment, the feeder 230 is not connected to the ground surface but may be realized so that a signal input node (not shown) of a PCB upon which the dual band antenna is realized supplies a current to the induction radiator 210.

FIG. 7 is a cross-sectional view illustrating examples of lengths of respective portions of an induction radiator and a parasitic radiator realized to resonate the dual band antenna of FIG. 6 in a dual band of frequencies of 5.3 GHz and 2.4 GHz. Although not shown, the induction radiator 210 and the parasitic radiator 220 are realized as plane strips and thus can each have a thickness of about 0.8 mm.

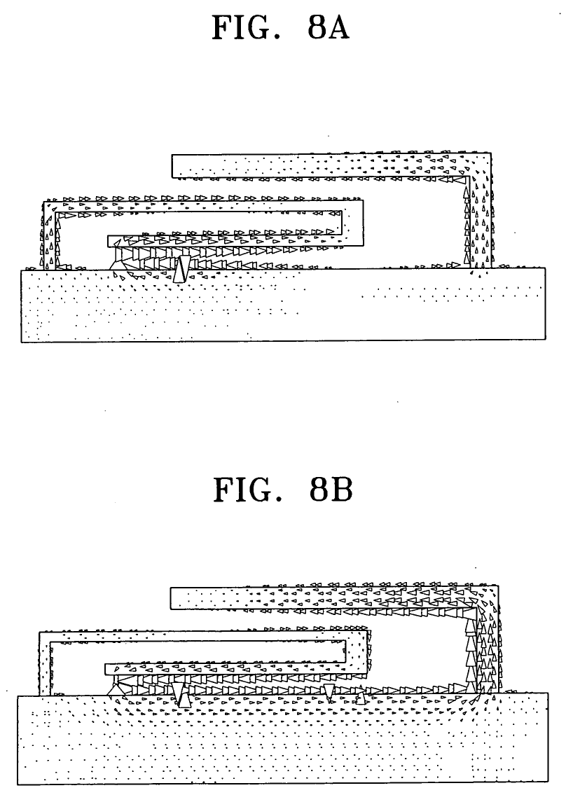

FIG. 8A is a cross-sectional view illustrating a distribution of a surface current during a high frequency resonance of the dual band antenna shown in FIG. 7. FIG. 8B is a cross-sectional view illustrating a distribution of a surface current during a low frequency resonance of the dual band antenna shown in FIG. 7

The induction radiator 210 connected to the feeder 230 forms the high frequency (roughly around 5 GHz) resonance as shown in FIG. 8A, and the parasitic radiator 220 is connected to the induction radiator 210 to form the low frequency (roughly around 2 GHz) resonance as shown in FIG. 8B.

The size of the conventional IFA shown in FIG. 2 is 15 mm×15 mm×6 mm at the operation of 2.4 GHz, while the size of the dual band antenna shown in FIG. 6 is greatly reduced, i.e., 20 mm×5 mm×0.8 mm at the operation frequency roughly around 2 GHz (2.4 GHz) or 5 GHz (5.4 GHz).

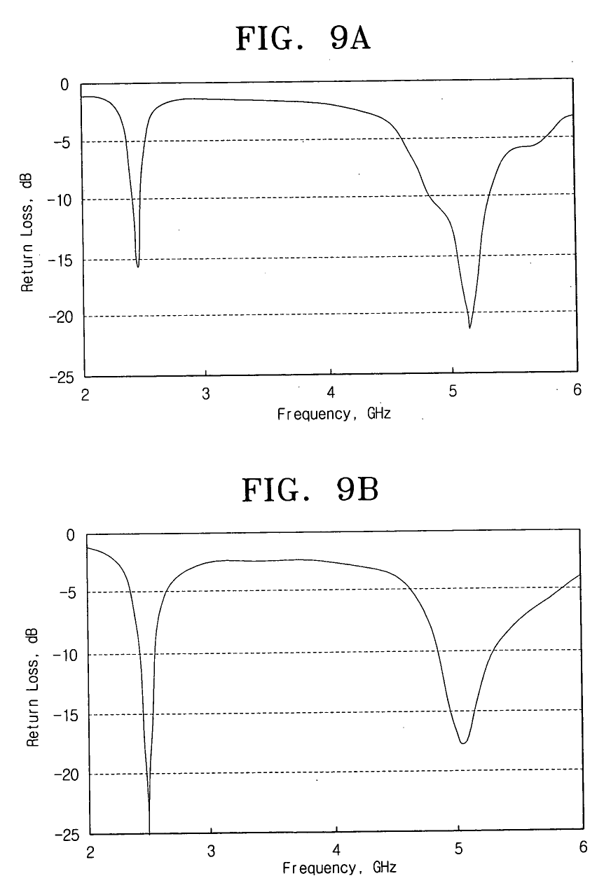

FIG. 9A is a graph illustrating a result of a return loss measured with respect to the operation frequency of the dual band antenna shown in FIG. 3. FIG. 9B is a graph illustrating a result of a return loss measured with respect to the operation frequency of the dual band antenna shown in FIG. 6.

As shown in FIGS. 9A and 9B, each of the dual band antennas shown in FIGS. 3 and 6 suddenly reduces a return loss at frequencies roughly around 2.4 GHz and 5 GHz to −10 dB or less. Thus, the dual band antennas shown in FIGS. 3 and 6 can be used in a low frequency band roughly around 2.4 GHz and a high frequency band roughly around 5 GHz.

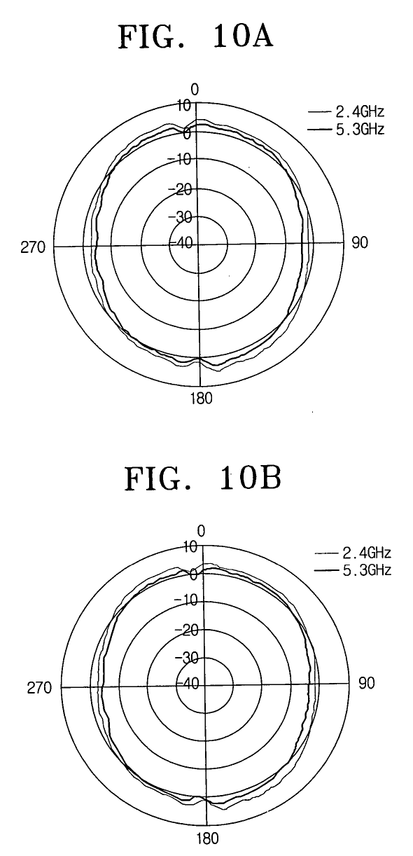

FIG. 10A is a graph illustrating a measured result of a radiation pattern of the dual band antenna shown in FIG. 3. FIG. 10B is a graph illustrating a measured result of a radiation pattern of the dual band antenna shown in FIG. 6.

As shown in FIGS. 10A and 10B, the dual band antennas shown in FIGS. 3 and 6 have uniform radiation patterns at frequencies roughly around 2.4 GHz and 5 GHz.

As described above, according to the present invention, an induction radiator and a parasitic radiator can be disposed on the same plane as a ground surface. Thus, an antenna having a smaller size than an existing IFA can be provided.

Also, the induction radiator and the parasitic radiators can form resonances in two frequency bands to provide a dual band antenna that can be used in a dual band.

In addition, a feeder can be realized so that a signal input node of a PCB can directly supply a current to the induction radiator. Thus, a process of manufacturing the dual band antenna can be simplified.

The foregoing embodiments and advantages are merely exemplary in nature and are not to be construed as limiting the present invention. The present teaching can be readily applied to other types of apparatuses. Also, the description of the exemplary embodiments of the present invention is intended to be illustrative, and therefore it does not limit the scope of the claims. Alternatives, modifications, and variations of the exemplary embodiments described herein will be readily apparent to those skilled in the art.

What is claimed is:

1. A dual band antenna comprising:
a ground surface;
a feeder which feeds a current;
an induction radiator comprising one end connected to the ground surface and the other end connected to the feeder; and
a parasitic radiator comprising one end connected to the ground surface and the other end opened.

2. The dual band antenna of claim 1, wherein the induction radiator and the parasitic radiator form resonances in two frequency bands.

3. The dual band antenna of claim 2, wherein the induction radiator forms the resonance in a high frequency band of the two frequency bands, and the parasitic radiator is connected to the induction radiator to form the resonance in a low frequency band of the two frequency bands.

4. The dual band antenna of claim 3, wherein the high frequency band is at or approximately 5 GHz, and the low frequency band is at or approximately 2.4 GHz.

5. The dual band antenna of claim 1, wherein the induction radiator is a strip folded at least one time.

6. The dual band antenna of claim 1, wherein the parasitic radiator is a strip folded at least one time.

7. The dual band antenna of claim 1, wherein the induction radiator and the parasitic radiator are formed on an identical plane of the ground surface.

8. The dual band antenna of claim 7, wherein the induction radiator comprises:
a first induction radiator strip comprising an end vertically connected to a side of the ground surface;
a second induction radiator strip comprising one end connected to other end of the first induction radiator strip and disposed horizontally to the side of the ground surface;
a third induction radiator strip comprising one end connected to other end of the second induction radiator strip and disposed vertically to the side of the ground surface; and
a fourth induction radiator strip, comprising one end connected to other end of the third induction radiator strip and other end of the fourth induction radiator strip connected to the feeder and disposed horizontally to the side of the ground surface.

9. The dual band antenna of claim 8, wherein the first through fourth induction radiator strips are formed of a single body.

10. The dual band radiator of claim 7, wherein the parasitic radiator comprises:
a first parasitic radiator strip comprising one end vertically connected to the side of the ground surface;
a second parasitic radiator strip comprising one end connected to other end of the first parasitic radiator strip and disposed horizontally to the side of the ground surface;
a third parasitic radiator strip comprising one end connected to other end of the second parasitic radiator strip and disposed vertically to the side of the ground surface; and
a fourth parasitic radiator strip comprising one end connected to other end of the third parasitic radiator strip and other end of the fourth parasitic radiator strip opened and disposed horizontally to the side of the ground surface.

11. The dual band antenna of claim 10, wherein the first through fourth parasitic radiator strips are formed of a single body.

12. The dual band antenna of claim 7, wherein the parasitic radiator comprises:
a first parasitic radiator strip comprising an end vertically connected to the side of the ground surface; and
a second parasitic radiator strip comprising one end connected to other end of the first parasitic radiator strip and other end of the second parasitic radiator strip opened and disposed horizontally to the side of the ground surface.

13. The dual band antenna of claim 12, wherein the first and second parasitic radiator strips are formed of a single body.

14. The dual band antenna of claim 12, wherein the second parasitic radiator strip keeps a longer distance from the side of the ground surface than the third induction radiator strip.

15. The dual band antenna of claim 1, wherein the feeder is realized so that a signal input node PCB (printed circuit board) upon which the dual band antenna is formed directly supplies a current to the induction radiator.
